(19) United States
(12) Patent Application Publication
(10) Pub. No.: US 2025/0131701 A1
(43) Pub. Date: Apr. 24, 2025

(54) IMAGE PROCESSING APPARATUS, IMAGE CAPTURING APPARATUS, CONTROL METHOD, AND RECORDING MEDIUM

(71) Applicant: CANON KABUSHIKI KAISHA, Tokyo (JP)

(72) Inventor: Dai MIYAUCHI, Chiba (JP)

(21) Appl. No.: 18/915,432

(22) Filed: Oct. 15, 2024

(30) Foreign Application Priority Data
Oct. 24, 2023 (JP) 2023-182752

(51) Int. Cl. G06V 10/82; G06V 10/26

(52) U.S. Cl. CPC G06V 10/82; G06V 10/26

(57) ABSTRACT

An image processing apparatus executes convolutional computation processing in a neural network with respect to input data, obtains a plurality of tiles that respectively correspond to partial regions in an image and performs control so as to cause the convolutional computation processing to be executed while using each of the plurality of tiles as the input data. The control is performed so that, with respect to at least a part of the plurality of tiles, overlapping pixels which are included in the at least the part of the plurality of tiles and which correspond to the same region in the image as another tile are excluded from a target of the convolutional computation processing.

### BACKGROUND OF THE INVENTION

### Field of the Invention

The present invention relates to an image processing apparatus, an image capturing apparatus, a control method, and a recording medium, and especially to an image processing technique that uses a neural network.

### Description of the Related Art

In recent years, deep learning techniques that use a neural network have been utilized in a wide range of technical fields. In particular, a convolutional neural network (CNN) has been widely utilized in the field of image processing. In the convolutional neural network, high-precision learning can be realized by using feature amounts of an image obtained by performing convolutional computation recursively (Japanese Patent Laid-Open No. 2019-125128).

Incidentally, there is a broad demand for deep learning processing that uses a CNN; in recent years, such deep learning processing has become executable in real time not only on a server that has a predetermined computation capability, but also on a variety of edge devices. For example, hardware that is dedicated to a CNN in the form of an AI chip, an IP, or the like (hereinafter referred to as a CNN computation unit) is also in circulation, and deep learning processing can be executed on an edge device by incorporating such hardware.

Although a CNN computation unit includes a buffer for holding data targeted for computation, the size of this buffer is limited. Due to an increased number of pixels in recent image sensors, the size of image data handled by digital cameras or the like is increasing; in order for the CNN computation unit to process an image, it is necessary to divide this image into tiles that are smaller in size than the buffer, and to cause the CNN computation unit to process the image on a per-tile basis.

Meanwhile, when tiles are configured by dividing an image simply based on regions, a favorable processing result may not be achieved in an edge portion, which corresponds to a boundary between tiles. This is attributed to the fact that convolutional computation is performed with respect to one pixel in the image by referring to this pixel and pixels distributed therearound. That is to say, as it is not possible to refer to pixels that are not included in a tile, that is to say, pixels that are not held in the buffer of the CNN computation unit, the processing result of the convolutional computation becomes different from the processing result achieved without division into tiles.

For this reason, in order to achieve a favorable processing result for the entire image, it is necessary to configure each tile to be input to the CNN computation unit in such a manner that the tile includes not only a region obtained by simply dividing the image, but also pixels therearound. In other words, each of a plurality of tiles which are sequentially input to the CNN computation unit and to which the convolutional computation is applied is configured to include a pixel region that overlaps another tile.

However, configuring tiles that include such overlapping pixel regions results in an increase in a processing time period compared to a case where the convolutional computation is applied to the image without division.

### SUMMARY OF THE INVENTION

The present invention has been made in view of the aforementioned problem, and provides an image processing apparatus, an image capturing apparatus, a control method, and a recording medium that efficiently execute convolutional computation processing with respect to an image.

The present invention in its first aspect provides an image processing apparatus, comprising: at least one processor and/or circuit; and at least one memory storing computer program, which causes the at least one processor and/or circuit to function as following units: a computation unit configured to execute convolutional computation processing in a neural network with respect to input data, an obtainment unit configured to obtain a plurality of tiles that respectively correspond to partial regions in an image, and a control unit configured to perform control so as to cause the computation unit to execute the convolutional computation processing while using each of the plurality of tiles as the input data, wherein the control unit controls the computation unit so that, with respect to at least a part of the plurality of tiles, overlapping pixels which are included in the at least the part of the plurality of tiles and which correspond to the same region in the image as another tile are excluded from a target of the convolutional computation processing.

The present invention in its second aspect provides an image capturing apparatus, comprising: an image capturing unit; and the image processing apparatus of the first aspect, wherein the obtainment unit obtains the plurality of tiles based on the image that has been obtained through image capture performed by the image capturing unit.

The present invention in its third aspect provides a control method for an image processing apparatus, the control method comprising: executing convolutional computation processing in a neural network with respect to input data; obtaining a plurality of tiles that respectively correspond to partial regions in an image; and performing control so as to cause the convolutional computation processing to be executed while using each of the plurality of tiles as the input data, wherein the control is performed so that, with respect to at least a part of the plurality of tiles, overlapping pixels which are included in the at least the part of the plurality of tiles and which correspond to the same region in the image as another tile are excluded from a target of the convolutional computation processing.

The present invention in its fourth aspect provides a computer-readable recording medium storing a program for causing a computer to execute the control method of the third aspect.

Further features of the present invention will become apparent from the following description of exemplary embodiments (with reference to the attached drawings).

### BRIEF DESCRIPTION OF THE DRAWINGS

FIG. 1 is a block diagram showing an exemplary hardware configuration of an image processing apparatus 100 according to embodiments and modification examples of the present invention.

FIGS. 2A to 2E are diagrams illustrating a plurality of tiles generated from a processing target image in relation to CNN computation according to embodiments and modification examples of the present invention.

FIGS. 3A and 3B are diagrams illustrating convolutional computation processing executed by a multiply accumulation processing unit 103 according to embodiments and modification examples of the present invention.

FIGS. 4A to 4C are diagrams exemplarily showing arrangements of data related to CNN computation in a memory space according to embodiments and modification examples of the present invention.

FIG. 5 is a flowchart exemplarily showing level computation processing executed by the image processing apparatus 100 according to embodiments and modification examples of the present invention.

FIG. 6 is a flowchart exemplarily showing generation processing executed by the image processing apparatus 100 according to embodiments and modification examples of the present invention.

FIGS. 7A, 7B and 7C are diagrams illustrating a reception field of CNN computation according to a second embodiment of the present invention.

FIG. 8 is a diagram illustrating a plurality of tiles generated from a processing target image in relation to CNN computation according to a third embodiment of the present invention.

### DESCRIPTION OF THE EMBODIMENTS

### First Embodiment

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

The following description of an embodiment will be provided using an example in which the present invention is applied to an image processing apparatus configured to be capable of executing convolutional computation processing in a CNN with respect to a captured image, which is one example of an image processing apparatus. However, the present invention is applicable to any device capable of executing image processing including the convolutional computation processing with respect to an image that has been input as a plurality of tiles.

### Configuration of Image Processing Apparatus>>

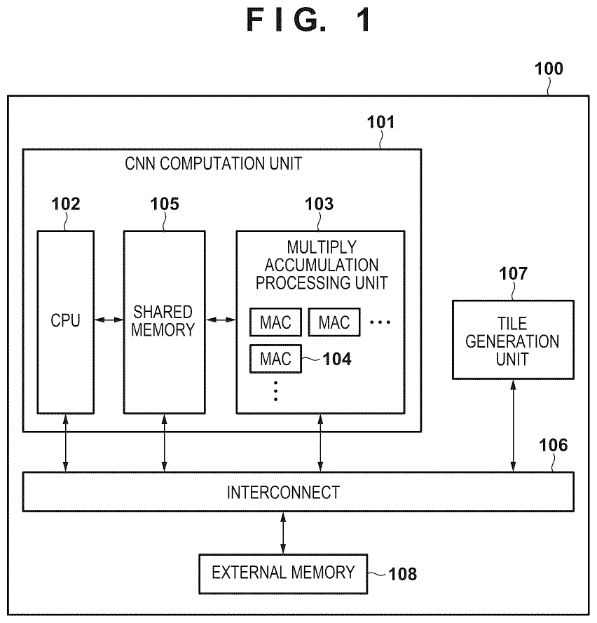

FIG. 1 is a block diagram showing a hardware configuration of an image processing apparatus 100 according to the present embodiment. The image processing apparatus 100 is an apparatus configured to be capable of executing image processing that uses a neural network, which is used in deep learning and the like. In the present embodiment, the image processing apparatus 100 is configured to be capable of executing various types of computation related to the neural network with respect to a captured image. The following description will be provided under the assumption that the image processing apparatus 100 is capable of executing image processing including various types of computation (hereinafter referred to as CNN computation) related to a convolutional neural network that mainly handles images, which is one form of a neural network.

A CNN computation unit 101 executes the CNN computation in the image processing apparatus 100. As shown in the figure, in the present embodiment, the CNN computation unit 101 is configured to include a CPU 102, multiply accumulation processing unit 103, and a shared memory 105.

The CPU 102 is a control apparatus that controls the operations of each block included in the image processing apparatus 100. The CPU 102 includes, for example, a ROM and a RAM arranged therein, and can control the operations of each block by reading out an operation program for each block from the ROM, deploying the operation program to the RAM, and executing the operation program. Although the details will be described later, the CPU 102 controls the operations by supplying various types of parameters necessary for the execution of the CNN computation to each block. Note that although the CPU 102 is included in the CNN computation unit 101 in the example of FIG. 1, it goes without saying that it may be provided outside the CNN computation unit 101.

The multiply accumulation processing unit 103 executes convolutional computation processing, which is the core of the CNN computation. The multiply accumulation processing unit 103 includes a plurality of multiply accumulation cores (MACs) 104. In the convolutional computation processing, the MACs 104 are controlled to repeatedly perform MAC computation with respect to input data that has been input to the multiply accumulation processing unit 103.

The shared memory 105 is a storage apparatus configured to be accessible from the CPU 102, the multiply accumulation processing unit 103, and an interconnect 106. For example, parameters used in the convolutional computation processing and the result of the convolutional computation processing can be stored in the shared memory 105.

The interconnect 106 is an interface that realizes data communication inside and outside the CNN computation unit 101. More specifically, the interconnect 106 realizes mutual connection among the CPU 102, the multiply accumulation processing unit 103, the shared memory 105, a tile generation unit 107, and an external memory 108, and performs data communication based on a predetermined protocol. Although the present embodiment will be described under the assumption that data communication among discrete blocks is realized via the interconnect 106, it is to be understood that embodiments of the present invention are not limited to this.

The tile generation unit 107 generates data of tiles for which the convolutional computation processing is to be executed. With respect to an image targeted for the CNN computation, the multiply accumulation processing unit 103 of the present embodiment does not execute the convolutional computation processing for all regions at a time, but executes the convolutional computation processing for each tile extracted from this image. That is to say, regarding the tiles generated by the tile generation unit 107, the CNN computation in the CNN computation unit 101 of the present embodiment is executed for each of the tiles generated by the tile generation unit 107. The tile generation unit 107 generates data of a tile by extracting pixels included in each of a plurality of partial regions set in the image.

The external memory 108 is a storage apparatus that stores, for example, an image targeted for the CNN computation (which may also be referred to as a processing target image), and parameters used in the convolutional computation processing. In general, the external memory 108 is composed of a storage apparatus that has a slower speed and a larger capacity than the shared memory 105.

### <<Generation of Tiles>>

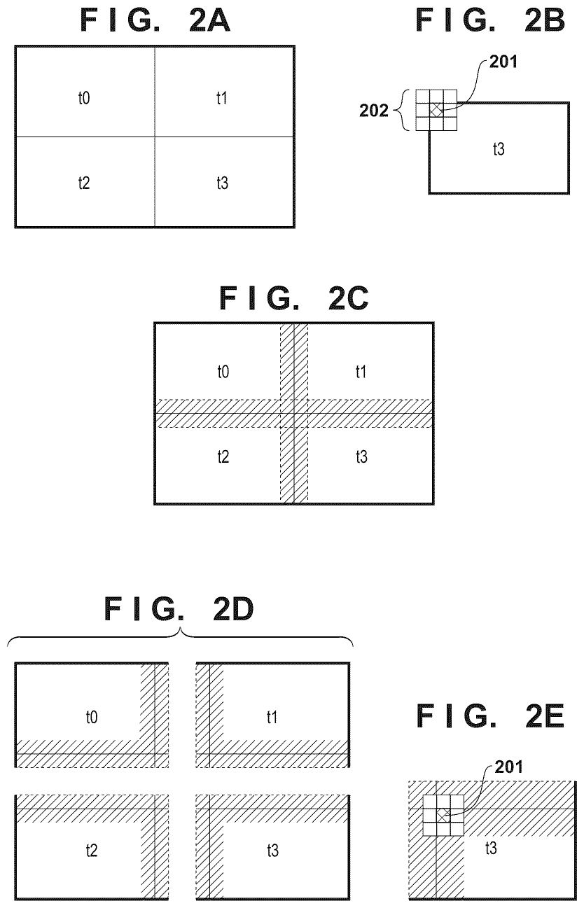

Next, generation of tiles by the tile generation unit 107 based on a processing target image will be described with reference to FIGS. 2A to 2E. Note that the present embodiment will be described under the assumption that the tile generation unit 107 generates four tiles based on the processing target image.

FIG. 2A exemplarily shows a mode in which the processing target image is divided into equal halves in the horizontal direction, and divided into equal halves in the vertical direction, hence divided into four tiles. That is to say, the mode shown in FIG. 2A represents a mode in which tiles are generated by dividing the processing target image simply based on regions. In the figure, the four tiles are identified with labels “to”, “t1”, “t2”, and “t3” appended to the upper-left tile, the upper-right tile, the lower-left tile, and the lower-right tile in the processing target image, respectively.

Although the details will be described later, in the convolutional computation processing executed in the multiply accumulation processing unit 103, with respect to each pixel in input data, filter processing is executed in which pixel values of this pixel and peripheral pixels placed around this pixel are referred to. Regarding a pixel located at an edge of an image, as peripheral pixels are not included in this image, computation is performed in this filter processing while regarding the pixel values of non-existent peripheral pixels as 0, for example. Therefore, also in a case where the processing target image has been divided into tiles and the convolutional computation processing has been executed with respect to each tile in the mode shown in FIG. 2A, pixels that are not included in the tile are referred to in computation as shown in FIG. 2B.

FIG. 2B exemplarily shows a pixel group 202 that is referred to when filter processing based on a 3×3 filter kernel is executed with respect to a pixel 201 at the upper-left edge of the tile “t3” shown in FIG. 2A. As shown in the figure, as five peripheral pixels in the pixel group 202 are not included in the tile t3, computation is performed while replacing the pixel values of these peripheral pixels with, for example, 0 in the filter processing for the pixel 201.

On the other hand, in a case where the filter processing has been executed with respect to the entirety of the processing target image without division into tiles, as pixels exist around the pixel 201, the computation result is achieved by referring to significant pixel values possessed by these pixels in the filter processing. Therefore, in a case where the convolutional computation processing has been executed with respect to each tile after generating tiles in the mode shown in FIG. 2A, the computation results achieved for pixels distributed at edges of a tile are different from those achieved in a case where computation has been executed without division into tiles. That is to say, in the mode of FIG. 2A, as pixel values of pixels that can originally be referred to are not usable in computation in the convolutional computation processing with respect to a part of tiles, a favorable computation result cannot be achieved. As a result, the processing accuracy of image processing that is executed in the CNN computation unit 101 by dividing a processing target image into tiles according to the mode of FIG. 2A becomes lower than that of a case where the image processing is executed without division into tiles.

In view of this, in the image processing apparatus 100 of the present embodiment, the tile generation unit 107 generates four tiles based on a processing target image in a mode where the tiles include overlapping regions as indicated by hatching in FIG. 2C. More specifically, the tile generation unit 107 sets four partial regions related to tiles to be generated for the processing target image so that each of them at least overlaps neighboring partial regions, and generates each tile by extracting pixels included in each partial region. In FIG. 2C, solid lines shown inside the processing target image are presented for comparison with the mode of FIG. 2A, and represent a line that divides the processing target image into equal halves in the horizontal direction, and a line that divides the processing target image into equal halves in the vertical direction. Edges of each tile are indicated by dash lines in FIG. 2C, and FIG. 2D shows a mode in which the discrete tiles have been separated. That is to say, the tiles generated by the tile generation unit 107 of the present embodiment have larger areas than the tiles obtained by simply dividing the processing target image into four equal parts as shown in FIG. 2A. Furthermore, each tile generated by the tile generation unit 107 includes pixels that are not included in a tile that is located at the same relative position (a tile with the same label) inside the processing target image in the mode of FIG. 2A.

In other words, the plurality of tiles generated by the tile generation unit 107 of the present embodiment respectively correspond to four partial regions which are set in the processing target image, and each of which includes a region that at least overlaps another neighboring partial region. In the following description, a pixel included in a region in which neighboring partial regions overlap each other will be referred to as an overlapping pixel. That is to say, in the mode of FIGS. 2C and 2D, the tile “t0” includes at least overlapping pixels that overlap the tile “t1”, and overlapping pixels that overlap the tile “t2”. Also, the tile “t1” includes at least overlapping pixels that overlap the tile “to”, and overlapping pixels that overlap the tile “t3”. Furthermore, the tile “t2” includes at least overlapping pixels that overlap the tile “t0”, and overlapping pixels that overlap the tile “t3”. Similarly, the tile “t3” includes at least overlapping pixels that overlap the tile “t1”, and overlapping pixels that overlap the tile “t2”.

FIG. 2E exemplarily shows the tile labeled “t3”, which has been generated based on a partial region set in the mode of FIG. 2C. As shown in the figure, the tile “t3” generated by the tile generation unit 107 of the present embodiment includes all of the peripheral pixels of the pixel 201 located at the upper-left edge of the same tile t3 in the mode of FIG. 2A. Therefore, the computation result of filter processing for this pixel 201 is the same as the computation result of a case where the filter processing has been executed with respect to this pixel without dividing the processing target image. As a result, the processing accuracy of image processing that is executed in the CNN computation unit 101 by generating tiles according to the mode of FIG. 2C from the processing target image does not become lower than that of a case where the image processing is executed without division into tiles.

### <<CNN Computation>>

A convolutional neural network is one form of a neural network used in image recognition and the like. The CNN computation unit 101 can mainly execute CNN computation, which includes convolutional computation processing in a convolutional neural network. For example, when executed with respect to an image, the convolutional computation processing can derive feature amounts of this image. The feature amounts that have been derived in this way can be utilized in deep learning and various types of image analysis.

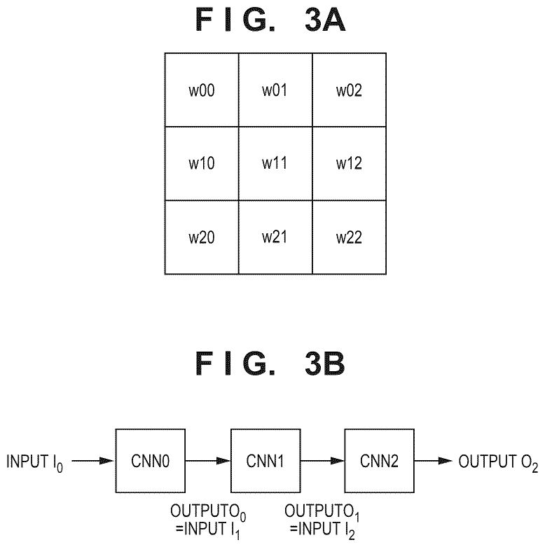

The following describes an outline of the CNN computation executed by the CNN computation unit 101 with reference to FIGS. 3A and 3B.

As described above, filter processing is executed in the convolutional computation processing included in the CNN computation. In the present embodiment, it is assumed that the filter processing uses a filter kernel with a kernel size of 3 pixels×3 pixels. It is assumed here that the multiply accumulation processing unit 103 of the present embodiment is configured so that an image size does not change between input data (an input image) and output data (an output image). To this end, prior to the filter processing, the multiply accumulation processing unit 103 uses zero padding to add a width corresponding to one pixel to each of the top, bottom, left, and right of the input image. That is to say, regarding pixels in each tile generated by the tile generation unit 107, one horizontal pixel line is added to each of the top and bottom of the tile, and one vertical pixel line is added to each of the left and right of the tile, by way of zero padding. That is to say, in the convolutional computation processing executed by the multiply accumulation processing unit 103, an image obtained by further adding pixels related to zero padding to a pixel group of a tile that serves as an input image, which includes overlapping pixels, is the target of convolutional computation.

The filter processing pertaining to the convolutional computation processing is executed with respect to each position while moving the filter kernel of the predetermined size in a raster order from the upper left of an input image. The filter kernel is intended to define a pixel group that is referred to in the filter processing, and a calculation result corresponding to a pixel located at the center of the filter kernel is obtained through the filter processing. In other words, the filter processing pertaining to the convolutional computation processing performs computation by referring to the pixel values of pixels included in a region of the kernel size (3×3), which is centered at a target pixel, while changing the position of the target pixel in the raster order, thereby obtaining output values (computation results) related to the target pixels.

Here, provided that filter coefficients w of the filter kernel are as shown in FIG. 3A, the convolutional computation processing for a target pixel x can derive a computation result (an output value Out(x)) using the following formula (1).

$$Out ( x ) = a ( w 00 \cdot x 00 + w 01 \cdot x 01 + w 02 \cdot x 02 \qquad ( 1 )$$

$$+ w 10 \cdot x 10 + w 11 \cdot x 11 + w 12 \cdot x 12$$

$$+ w 20 \cdot x 20 + w 21 \cdot x 21 + w 22 \cdot x 22$$

$$+ b )$$

Here, x denotes a pixel value in an image targeted for the convolutional computation, and an appended numeral corresponds to the position of the filter coefficient with the same appended numeral. That is to say, the pixel value of the target pixel x is x11, and is multiplied by the filter coefficient w11, which corresponds to the center of the filter kernel, in formula (1). Also, a denotes an activation function; for example, a rectified linear unit (Relu) can be used thereas. Furthermore, b denotes a bias value. Hereinafter, the filter coefficient and the bias value are collectively called a “model parameter”. The model parameter is a parameter used in the convolutional computation processing; it is stored in advance in, for example, the external memory 108, read out by the CPU 102, and applied by the multiply accumulation processing unit 103. By selecting a model parameter, the CNN computation unit 101 becomes usable for the purpose of deep learning and the like.

As shown in FIG. 3B, in the CNN computation performed in the CNN computation unit 101 of the present embodiment, the convolutional computation processing is repeatedly executed multiple times with respect to an input image I₀. More specifically, the CNN computation, which is repeatedly performed as shown in the figure, is performed hierarchically in such a manner that the act of using a computation result (output data) of convolutional computation processing as input data of convolutional computation processing to be performed next is repeated a predetermined number of times.

The example of FIG. 3B represents a mode in which a computation result (output O₂) of the CNN computation is obtained by executing convolutional computation processing with respect to the input image I₀ in three stages (CNN0, CNN1, and CNN2). Here, CNN0, CNN1, and CNN2 in the CNN computation are each referred to as a layer (level), which is equivalent to a convolutional layer in the convolutional neural network. That is to say, in the CNN computation, output data of a preceding layer is used as input data of the next layer. In other words, the output O₀ of CNN0 is the input I₁ of CNN1, and the output O₁ of CNN1 is the input I₂ of the CNN2. Furthermore, CNN0 may be referred to as an input layer, meaning that a processing target image is input thereto, and CNN1 and CNN2 may be referred to as succeeding layers, meaning that they use output data of a preceding layer. Note that data between discrete levels may be referred to as an intermediate feature image.

Accordingly, the CPU 102 issues an instruction indicating a level relationship and a model parameter to be used to the multiply accumulation processing unit 103 in accordance with the content of image processing to be executed as the CNN computation. Furthermore, the multiply accumulation processing unit 103 executes convolutional computation processing using the MACs 104 based on this instruction and stores output data, which is the computation result, into the shared memory 105, and the CPU 102 performs activation and the like; consequently, a CNN computation sequence is realized.

### <<Processing Related to Overlapping Pixels>>

Incidentally, in a mode in which each of a plurality of tiles generated by the tile generation unit 107 from a processing target image shares overlapping pixels with other tiles in the above-described manner, the processing time period is extended by the amount corresponding to the overlapping pixels compared to a case where CNN computation is performed without dividing the processing target image into tiles. That is to say, as the sum total of the numbers of pixels included in the plurality of tiles generated by the tile generation unit 107 is larger than the total number of pixels in the processing target image by the number of overlapping pixels in each tile, the number of times the convolutional computation processing is executed is also increased accordingly, thereby consequently extending the processing time period of CNN computation.

In order to alleviate such extension of the processing time period, the CNN computation unit 101 of the present embodiment executes processing for restricting the pixels for which the convolutional computation processing is to be executed by the multiply accumulation processing unit 103. More specifically, the CPU 102 inputs at least a part of the plurality of tiles to the multiply accumulation processing unit 103 while excluding the overlapping pixels for which the convolutional computation processing has already been executed in connection with another tile.

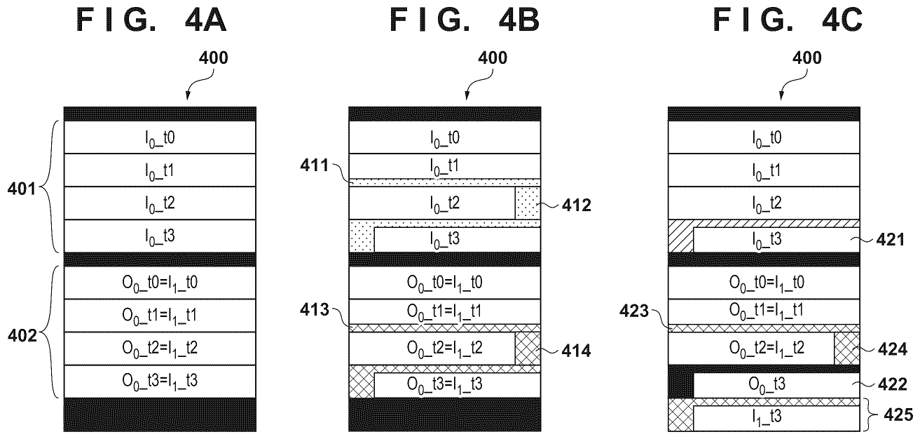

FIGS. 4A to 4C exemplarily show arrangements of data of each tile in a memory space 400, which is used in the convolutional computation processing in the multiply accumulation processing unit 103. Here, in order to clearly identify each type of data, tiles identify the positions of partial regions set in a processing target image and may be mentioned using the labels assigned thereto (t0, t1, t2, and t3) as necessary in the following description. Also, “input data of a tile” refers to data that is input to the multiply accumulation processing unit 103 (that the multiply accumulation processing unit 103 refers to from the shared memory 105) as a target of the convolutional computation processing. On the other hand, “output data of a tile” refers to data that is output as a computation result of the convolutional computation processing that has been executed with respect to this tile.

This memory space 400 is, for example, the shared memory 105, and data that is used in the course of CNN computation is arranged therein. Input data pieces 401 of a plurality of tiles, as well as output data pieces 411 representing the results of the convolutional computation processing for the respective input data pieces, are arranged in the memory space 400 in connection with the convolutional computation processing executed by the multiply accumulation processing unit 103 with respect to one level.

To facilitate the understanding of the invention, in the example of FIGS. 4A to 4C, the memory space 400 has a horizontal width that is equal in number to the number of pixels in the tiles generated by the tile generation unit 107 in the horizontal direction. In the example of FIGS. 4A to 4C, input data pieces of the four tiles (I₀_t0, I₀_t1, I₀_t2, and I₀_t3) are arranged as input data pieces 401 associated with the input layer (CNN0 of the first layer). The CPU 102 reads out the input data pieces of the tiles from the memory space 400 in the order t0, t1, t2, and t3, inputs them to the multiply accumulation processing unit 103, and causes the multiply accumulation processing unit 103 to execute the convolutional computation processing.

Here, in a case where the multiply accumulation processing unit 103 has executed the convolutional computation processing with respect to every pixel included in the input data pieces of the respective tiles, the output data pieces 402 of the four tiles are stored in the memory space 400 as shown in FIG. 4A. O₀_t0 denotes output data of t0, O₀_t1 denotes output data of t1, O₀_t2 denotes output data of t2, and O₀_t3 denotes output data of t3. As these output data pieces are input to CNN1 of the next layer, they are also handled as input data pieces of the four tiles associated with the next layer (I₁_t0, I₁_t1, I₁_t2, and I₁_t3).

However, partial regions corresponding to the input data pieces of tiles associated with the input layer overlap one another; with respect to the overlapping pixels included in these overlapping regions, the same computation can be performed in the convolutional computation processing for each of the plurality of tiles, and similar computation results can be output. More specifically, in a case where all of the overlapping pixels and the peripheral pixels thereof are included in the images of the tiles, there can be no change among the computation results of the convolutional computation processing. Therefore, when the multiply accumulation processing unit 103 executes the convolutional computation processing with respect to the overlapping pixels included in an arbitrary tile, there is a possibility that output data of another tile for which the convolutional computation processing has been executed therebefore already includes the computation result related to these overlapping pixels. In other words, there is a possibility that output data pieces of a plurality of tiles include the same computation result related to the overlapping pixels.

For example, as shown in FIG. 2C, the tile t3 includes overlapping pixels because the partial region corresponding thereto overlaps the tile t1 located thereabove and the tile t2 located to the left thereof. That is to say, taking a look at the input data I₀_t3 of t3, as indicated by dots in FIG. 4B, the same overlapping pixels are also included in data 411 located at the lower edge of the input data I₀_t1 of t1. Similarly, data 412 located at the right edge of the input data I₀_t2 of t2 also includes the same overlapping pixels as the input data I₀_t3 of t3. For this reason, the convolutional computation processing that is executed with respect to these overlapping pixels by referring to the same peripheral pixels yields the same computation result. Therefore, taking a look at the output data O₀_t3 of t3, the computation results 413 and 414 associated with the overlapping pixels are included in the output data O₀_t1 of t1 and the output data O₀_t2 of t2 as indicated by cross-hatching in the figure.

In view of the above, the image processing apparatus 100 of the present embodiment performs control to generate input data pieces of a plurality of tiles by setting partial regions including overlapping pixels in a processing target image, but avoid overlapping computation in the course of execution of the convolutional computation processing with respect to the input data pieces of the tiles in order. In the following example, in order to facilitate the understanding of the invention, with respect to input data of t3 corresponding to the partial region that has been set at the lower right of a processing target image, a pixel region that does not include overlapping pixels is input to the multiply accumulation processing unit 103, thereby excluding these overlapping pixels from the target of the convolutional computation processing. That is to say, as indicated by hatching in FIG. 4C, the CNN computation unit 101 of the present embodiment excludes the following pixels in the input data of t3 from the target of the convolutional computation processing: pixels at the upper edge, which overlap input data of t1, and pixels at the left edge, which overlap input data of t2. In other words, out of the pixel region that is illustrated as the input data of t3 in FIG. 4C, only a blank pixel region 421 that is not hatched is the target of the convolutional computation processing for the input data of t3.

Exclusion from the target of the convolutional computation processing can be realized by, for example, an execution command transmitted from the CPU 102 to the multiply accumulation processing unit 103 in relation to the input data of t3, and also by transmission of information of memory addresses of the pixel region obtained after excluding the overlapping pixels. The multiply accumulation processing unit 103 receives this information, reads out corresponding data from the shared memory 105, and executes the convolutional computation processing.

As the processing target of the multiply accumulation processing unit 103 as the input data of t3 is limited in the input layer in the above-described manner, the output data O₀_t3 of t3 (422) has a smaller size than output data associated with another partial region as shown in FIG. 4C. In this case, in order to cause the input data I₁_t3 of the next layer to have the same size as input data associated with another tile, the tile generation unit 107 may, for example, divert the computation result that has been achieved with respect to the overlapping pixels through processing for another tile into the output data O₀_t3 of t3. That is to say, information pieces 423 and 424 of pixels indicating the computation result related to the overlapping pixels are obtained from the output data O₀_t1 of t1 and the output data O₀_t2 of t2 as shown in the figure. Then, the obtained information pieces are combined with the output data O₀_t3 of t3 (422), thereby generating the input data I₁_t3 of t3 for the next layer (425). As a result, output data that has the same size as input data can be obtained for each partial region in relation to the convolutional computation processing for the input layer (CNN0).

Note that although the example of FIGS. 4A to 4C indicates control on input data in relation to the convolutional computation processing for the input layer (CNN0) in CNN computation, such control is not limited to being performed for the input layer, and can be performed for each level. That is to say, for example, when the multiply accumulation processing unit 103 executes the convolutional computation processing for CNN1, the CPU 102 can also execute processing for restricting the processing target of the multiply accumulation processing unit 103 similarly with respect to the input data I₁_t3 of t3 corresponding to the lower-right partial region.

Also, output data pieces of the plurality of tiles obtained through the convolutional computation processing for each level need not be composited into an image having the same size as the processing target image after the output data pieces of all tiles have been obtained in each level. Meanwhile, output data of each tile has the same size as input data, and a corresponding partial region in the processing target image does not change. That is to say, input data pieces or output data pieces of any level respectively correspond to partial regions associated with input data pieces of a plurality of tiles for the input layer of CNN computation. In other words, regarding a single tile, no matter which level the input data or the output data corresponds to, it correspond to the same partial region, and thus the pixel positions and the number of overlapping pixels therein do not change, either.

As described above, the CNN computation unit 101 of the present embodiment can reduce the amount of computation and the computation time period by restricting the target of the convolutional computation processing and diverting the computation result that has been achieved for another tile when performing CNN computation with respect to a processing target image divided into a plurality of tiles.

### <<Level Computation Processing>>

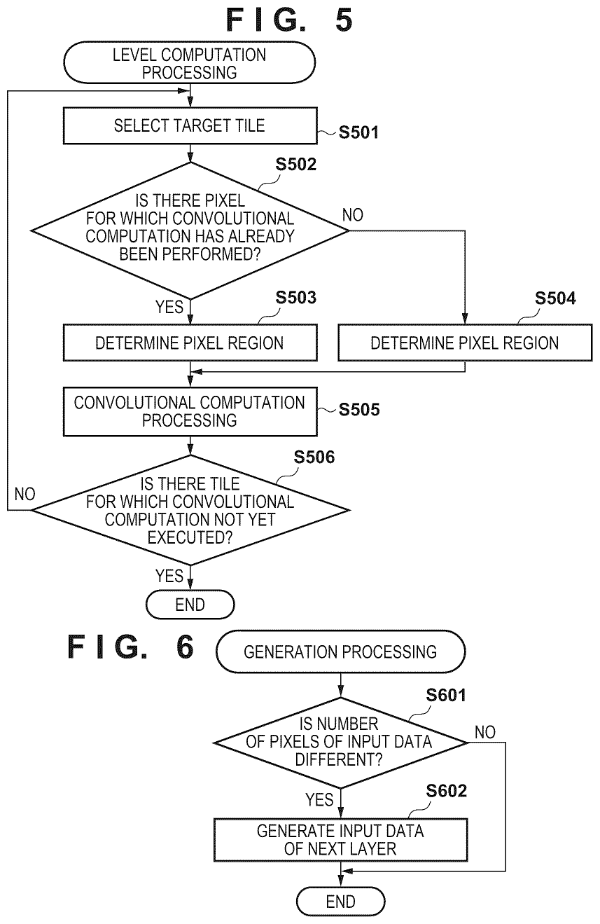

Using a flowchart of FIG. 5, the following provides a specific description of level computation processing that is executed by the CNN computation unit 101 of the present embodiment in connection with each level in CNN computation for a processing target image. The processing corresponding to this flowchart can be realized by the CPU 102 reading out a corresponding processing program stored in, for example, the external memory 108, deploying the processing program to the shared memory 105, and executing the processing program. The present level computation processing will be described under the assumption that it is started when, for example, executing processing for each level in the CNN computation with respect to the processing target image.

Note, it is assumed that, prior to the start of the present level computation processing, input data pieces of a plurality of tiles for which the convolutional computation processing is to be executed in the pertinent level are stored in the shared memory 105. In the input layer, these input data pieces of the plurality of tiles are generated by the tile generation unit 107 setting a predetermined number of partial regions in the processing target image and extracting pixels associated with these partial regions. Meanwhile, in the succeeding layers, the input data pieces of the plurality of tiles are either the output data pieces output through the convolutional computation processing that has been executed by the multiply accumulation processing unit 103 for the respective tiles in the preceding layer, or generated by combining these output data pieces.

In step S501, the CPU 102 selects a tile targeted for the convolutional computation processing (a target tile) based on a predetermined order.

In step S502, the CPU 102 determines whether pixels included in the input data of the target tile include pixels for which the convolutional computation processing in the same level has already been executed in connection with another tile. The determination of the present step is made based on whether the partial regions corresponding to the target tile and the tile that has been processed earlier include overlapping pixels. In a case the CPU 102 has determined that pixels included in the input data of the target tile include pixels for which the convolutional computation processing in the same level has already been executed in connection with another tile, the CPU 102 causes processing to proceed to step S503; in a case where the CPU 102 has not thus determined, it causes processing to proceed to step S504.

In step S503, the CPU 102 determines a pixel region (rectangular data) for which the convolutional computation processing is to be executed by the multiply accumulation processing unit 103 by excluding the pixels (overlapping pixels) for which the computation of the convolutional computation processing has already been completed from the input data of the target tile.

On the other hand, in a case where the CPU 102 has determined in step S502 that the input data of the target tile does not include pixels for which the convolutional computation processing has already been executed, the CPU 102 determines the entirety of the input data of the target tile as a pixel region for which the convolutional computation processing is to be executed in step S504.

In step S505, the CPU 102 causes the multiply accumulation processing unit 103 to execute the convolutional computation processing with respect to the target tile. At this time, the multiply accumulation processing unit 103 executes the convolutional computation processing while regarding the pixel region of the target tile determined in step S503 or S504 as the target of the convolutional computation processing, and stores the computation result into the shared memory 105 as output data of the target tile.

In step S506, the CPU 102 determines whether a tile for which the convolutional computation processing has not been executed in connection with the current level exists in the shared memory 105. In a case where the CPU 102 has determined that a tile for which the convolutional computation processing has not been executed exists, the CPU 102 causes processing to return to step S501; in a case where the CPU 102 has determined that no such tile exists, it ends the present level computation processing.

In this way, the image processing apparatus 100 of the present embodiment can reduce the number of pixels for which the convolutional computation processing is to be executed in each level when executing CNN computation with respect to a processing target image divided into a plurality of tiles; as a result, the amount of computation can be reduced.

### <<Generation Processing>>

Here, in a case where a pixel region for which the convolutional computation processing is executed is restricted with respect to input data of a specific tile, output data of this tile includes a smaller number of pixels than output data of another tile. In view of this, using a flowchart of FIG. 6, the following provides a specific description of processing that is executed by the image processing apparatus 100 to generate input data of the next layer so that input data of the next layer includes the same number of pixels for every tile (partial region). The processing corresponding to this flowchart can be realized by the CPU 102 reading out a corresponding processing program stored in, for example, the external memory 108, deploying the processing program to the shared memory 105, and executing the processing program. The present generation processing will be described under the assumption that it is started when, for example, convolutional computation processing for one target tile in the above-described level computation processing has been completed and output data of the target tile has been stored into the shared memory 105.

In step S601, under control of the CPU 102, the tile generation unit 107 determines whether the number of pixels in output data of a target tile is different from the number of pixels in input data of this target tile. In a case where the tile generation unit 107 has determined that the number of pixels in the output data of the target tile is different from the number of pixels in the input data thereof, the tile generation unit 107 causes processing to proceed to step S602; in a case where the tile generation unit 107 has determined that the numbers are the same, it ends the present generation processing.

In step S602, under control of the CPU 102, the tile generation unit 107 obtains information corresponding to the pixel positions of overlapping pixels from output data of another tile for which the convolutional computation processing has been executed before the target tile. Then, the tile generation unit 107 adds this information to the output data of the target tile, thereby generating input data of the next layer associated with the target tile. The input data of the next layer associated with the target tile includes the same number of pixels as the input data of the target tile and the input data of the next layer associated with another tile.

In this way, input data pieces of a plurality of tiles that include the same number of pixels can be easily generated for the next layer while reducing the amount of computation in the convolutional computation processing for a plurality of tiles in each level of the CNN computation.

As described above, the image processing apparatus 100 of the present embodiment can efficiently execute convolutional computation processing with respect to an image.

Note that although the present embodiment has been described under the assumption that the tile generation unit 107 generates a plurality of tiles by setting partial regions in a processing target image, the embodiments of the present invention are not limited to this. That is to say, a configuration that generates a plurality of tiles is not a configuration that is indispensable in embodying the present invention; for example, the present invention is also applicable to a mode in which a plurality of tiles generated by another apparatus are obtained and deployed to the shared memory 105. In this case, information of pixel positions related to pixels that overlap between tiles is also similarly obtained.

Furthermore, although the present embodiment has been described using a mode in which the present invention is applied to a convolutional layer of CNN computation as an example, the present invention is not limited to being embodied in this way, and is also applicable to, for example, a mode in which the present invention is applied to a fully connected layer and the like in a neural network.

Furthermore, in order to facilitate the understanding of the invention, the present embodiment has been described using a mode in which four tiles t0, t1, t2, and t3 are provided, and only with respect to t3 among these tiles, pixels that overlap neighboring tiles are excluded from the target of convolutional computation processing. However, the present invention is not limited to being embodied in this way, and is also applicable to a mode in which similar exclusion control is performed on the condition that a tile includes pixels that overlap another tile and convolutional computation processing has already been completed for this another tile. That is to say, the present invention is applicable to a mode in which convolutional computation processing is executed while using each of a plurality of tiles as input data and in which, with respect to at least a part of the tiles, overlapping pixels located in the same region as pixels in another tile within a processing target image are excluded from the target.

Furthermore, the present embodiment has been described under the assumption that a total of four partial regions, namely two partial regions in each of the horizontal direction and the vertical direction, are set in a processing target image so that the partial regions include overlapping pixels, and CNN computation is executed with respect to four tiles corresponding to these partial regions. However, the present invention is not limited to being embodied in this way; regarding the setting of partial regions, various modes can be adopted as long as a tile at least includes an overlapping region at a boundary with another tile. Also, a predetermined number of partial regions may be set in the processing target image, or the number thereof may be determined so that the data size of each tile falls below a predetermined capacity.

### First Modification Example

The above embodiment has been described using a mode that causes the multiply accumulation processing unit 103 to execute convolutional computation processing by designating a partial pixel region out of input data pieces of tiles from the CPU 102, thereby avoiding the convolutional computation processing in connection with overlapping pixels. However, the present invention is not limited to being embodied in this way; for example, the CPU 102 may input the input data pieces including overlapping pixels to the multiply accumulation processing unit 103, and the multiply accumulation processing unit 103 may execute the convolutional computation processing while excluding overlapping pixels based on a past computation result.

### Second Embodiment

The above embodiment and modification example have been described using a mode in which, in every level of CNN computation, pixels overlapping between partial regions set in a processing target image are excluded from the target of convolutional computation processing. Meanwhile, for example, in a mode that applies a 3×3 filter kernel or the like, the deeper the level, the wider the range of source pixels (reception field) in the processing target image that contribute to convolutional computation processing for one pixel.

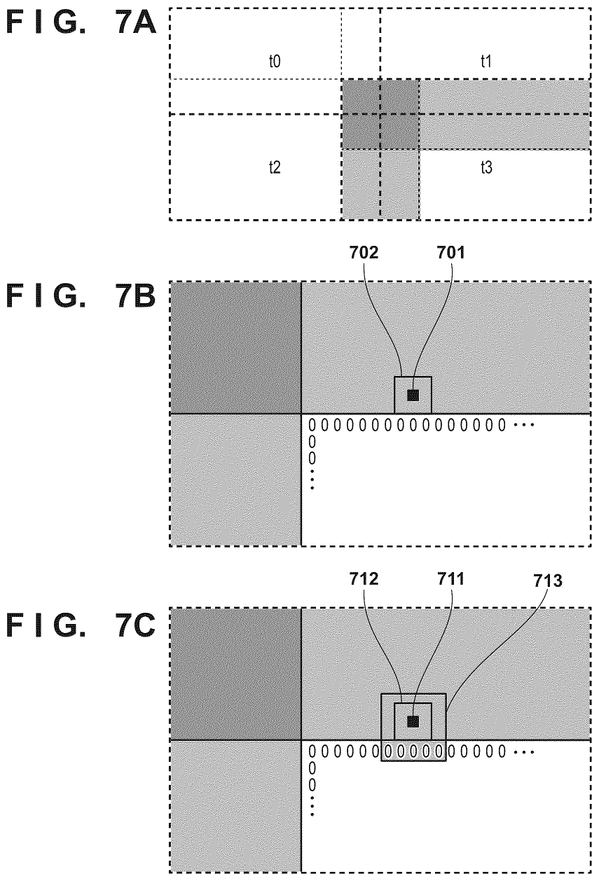

For example, in filter processing in an input layer for a region in which overlapping pixels are distributed within input data of t3 as shown in FIG. 7A, eight peripheral pixels included in a filter region 702 centered at a pixel 701 in this region serve as processing targets as shown in FIG. 7B. Regarding the pixel 701, as all of the eight peripheral pixels are included among the overlapping pixels, the computation result has been achieved in the convolutional computation processing for input data of t1; as a result, it can be excluded from the target of the convolutional computation processing for the input data of t3. On the other hand, in a layer next to the input layer, all of eight peripheral pixels included in a filter region 712 centered at a pixel 711 at the same pixel position are similarly included in the region of overlapping pixels as shown in FIG. 7C, but affected pixel positions differ in terms of the reception field. That is to say, the pixel value of each of the eight peripheral pixels included in the filter region 712 has been derived by referring to peripheral pixels thereof in the input layer, and a region 713 shown in FIG. 7C is the reception field thereof. In other words, a part of pixels included in the filter region 712 (three pixels aligned at the lower edge) represents pixels that have been generated by referring to pixels obtained through zero padding in the convolutional computation processing for input data of t1.

Therefore, in the convolutional computation processing for lower layers, even in the case of overlapping pixels, the computation result can vary between output data pieces of tiles. More specifically, in the layer next to the input layer, the pixel values of one horizontal pixel row at the lowermost edge of overlapping pixels included in output data of t1 have not been derived by referring to all of the pixels of the processing target image that are included in the reception field. Similarly, in the layer next to the input layer, the pixel values of one vertical pixel column at the rightmost edge of overlapping pixels included in output data of t2 have not been derived by referring to all of the pixels of the processing target image that are included in the reception field.

Therefore, as the size of the reception field associated with the convolutional computation processing becomes larger in a deeper level, the CNN computation unit 101 of the present embodiment performs control so that the number of pixels to be excluded from the target of the convolutional computation processing as overlapping pixels becomes smaller in a deeper level. In other words, depending on which level of CNN computation is subject to the convolutional computation processing executed by the multiply accumulation processing unit 103, the CPU 102 specifies overlapping pixels while changing pixels for which a prior computation result can be diverted based on the reception field, and excludes these overlapping pixels from the computation target.

In the example of FIG. 7C, regarding the convolutional computation processing in the second layer (CNN1), it is sufficient for the CPU 102 to specify, among pixels included in the input data of t3, pixels that overlap pixels in input data pieces of neighboring t1 and t2 in the following manner, for example. The CPU 102 specifies pixels overlapping between t1 and t3 by excluding one pixel row at the lowermost edge among pixels that overlap between the corresponding partial regions set in the processing target image. Also, the CPU 102 specifies pixels overlapping between t2 and t3 by excluding one pixel column at the rightmost edge among pixels that overlap between the corresponding partial regions set in the processing target image. It is to be easily understood that the foregoing specification of overlapping pixels in each level changes in accordance with the size of the filter kernel applied in filter processing of the convolutional computation processing and the depth of the level.

In this way, a reduction in the computation time period can be realized while increasing the computation accuracy of CNN computation.

### Third Embodiment

The above embodiments and modification example have been described using a method in which output data of convolutional computation processing for at least a part of tiles (t3) is generated by combining a computation result obtained by excluding overlapping pixels from input data with a computation result obtained for another tile with respect to these overlapping pixels. That is to say, in the mode shown in FIG. 4C, in order to generate output data corresponding to input data I₀_t3 of t3 (input data I₁_t3 of the next layer), a computation result of another tile is diverted into O₀_t3 obtained through the convolutional computation processing in which overlapping pixels have been excluded. At this time, in order to generate I₁_t3, it is necessary to access memory addresses that are indicated by hatching within O₀_t1 and O₀_t2 inside the shared memory 105 in FIG. 4B.

Incidentally, in a case where tiles have been generated by setting partial regions in a mode that divides a processing target image in the horizontal direction as in the above-described embodiments and modification example, there are two types of other tiles for which output data is diverted. Also, to read out pixel values in columns corresponding to n pixels at the right edge of the memory space as in O₀_t2 shown in FIG. 4B, complex memory accesses to discontinuous memory addresses are required. When memory accesses are discontinuous, they accordingly require a processing time period, thereby delaying the start of convolutional computation processing in the next layer. Conversely, readout of pixel values in a row corresponding to n pixels at the lower edge of the memory space as in O₀_t1 shown in FIG. 4B can be completed through memory accesses to memory addresses that are continuous in the raster order.

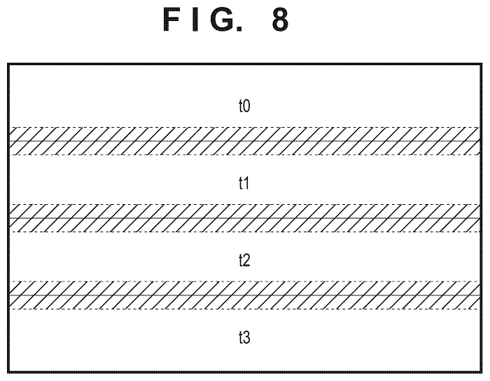

In view of this, in the present embodiment, the tile generation unit 107 generates a plurality of tiles by setting partial regions in such a manner that a processing target image is not segmentalized in the horizontal direction but is divided only in the vertical direction as shown in FIG. 8. That is to say, by generating a plurality of tiles based on partial regions shown in FIG. 8, memory accesses that are made in diverting output data of another tile can be memory accesses to memory addresses that are continuous in the raster order, similarly to O₀_t1 of FIG. 4B. By adopting such a mode of tile generation, memory accesses to discontinuous memory addresses can be avoided, and consequently, acceleration of processing related to CNN computation can be realized.

Note that the size of partial regions into which the processing target image is divided in the vertical direction and the number of partial regions to be set may be determined based on the size of the memory space prepared for input data of one tile. Here, the memory space prepared for input data of one tile is configured to be capable of storing data after adding pixels to the periphery of the tile generated by the tile generation unit 107 by way of zero padding and mirroring. Therefore, the size and the number of partial regions may be determined based on the number of these added pixels.

### Second Modification Example

Although the above third embodiment has been described using a mode that increases the efficiency of memory accesses at the time of generation of input data of the next layer by generating tiles while setting partial regions in such a manner that a processing target image is divided only in the vertical direction, embodiments of the present invention are not limited to this. For example, also in a mode that generates tiles by setting partial regions in such a manner that a processing target image is divided also in the horizontal direction, similar advantageous effects can be achieved by sequentially selecting tiles that neighbor one another in the vertical direction, rather than the raster order starting from the upper-left tile, as the order of convolutional computation processing. In this case, the CPU 102 repeats a selection of a tile corresponding to a partial region that neighbors, in the vertical direction, a partial region corresponding to the tile to which computation has been applied most recently as a tile for which the convolutional computation processing is to be executed next.

### Third Modification Example

Although the above embodiments and modification examples have been described under the assumption that the number of pixels in input/output data does not change in convolutional computation processing in each level of CNN computation, embodiments of the present invention are not limited to this. For example, when computation is performed without applying zero padding or the like to input data in the convolutional computation processing, output data is data that includes a smaller number of pixels than the input data. In this case, each of input data pieces of the next layer is similarly data that includes a smaller number of pixels than input data of the preceding layer.

Furthermore, it is to be easily understood that, in this mode, the criterion of determination in step S601 and the number of pixels for which output data of another tile is diverted change in the generation processing for generating input data of the next layer. For example, in a mode that applies a 3×3 filter kernel, output data obtained through the convolutional computation processing is two pixels smaller than input data in both of the horizontal direction and the vertical direction.

### Fourth Modification Example

Although the above embodiments and modification examples have been described under the assumption that a plurality of tiles are generated from a processing target image by setting a plurality of partial regions of an equal size so that the partial regions include the same number of overlapping pixels, embodiments of the present invention are not limited to this. It is to be easily understood that the present invention is also applicable to a case where the number of pixels that overlap between partial regions varies with each tile.

### Fifth Modification Example

Although the above embodiments and modification examples have been described under the assumption that the multiply accumulation processing unit 103 executes multiply accumulation related to filter processing as computation in a convolutional layer associated with CNN computation, the multiply accumulation processing unit 103 can also be configured to perform activation function computation or the like. Furthermore, although the description has been provided under the assumption that a computation result (output data) obtained by the multiply accumulation processing unit 103 is stored into the shared memory 105, the output data can also be stored into, for example, another storage apparatus, such as the external memory 108. In these modes, in diverting output data related to a tile for which computation has been performed earlier, processing for reading this output data into the shared memory 105 becomes necessary.

### Sixth Modification Example

The above embodiments and modification examples have been described under the assumption that the image processing apparatus 100 is an individual apparatus that obtains a captured image and performs CNN computation. Such an image processing apparatus 100 can be built in, for example, an image capturing apparatus, and can be used in such a manner that it generates a plurality of tiles with respect to a captured image obtained through image capture and performs CNN computation sequentially.

### Seventh Modification Example

Although the above embodiments and modification examples have been described under the assumption that the target of CNN computation performed by the CNN computation unit 101 is a two-dimensional image, the present invention is also applicable to a case where the target is data other than a two-dimensional image (e.g., three-dimensional data).

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-182752, filed Oct. 24, 2023 which is hereby incorporated by reference herein in its entirety.

What is claimed is:

1. An image processing apparatus, comprising:
at least one processor and/or circuit; and
at least one memory storing computer program, which causes the at least one processor and/or circuit to function as following units:
a computation unit configured to execute convolutional computation processing in a neural network with respect to input data,
an obtainment unit configured to obtain a plurality of tiles that respectively correspond to partial regions in an image, and
a control unit configured to perform control so as to cause the computation unit to execute the convolutional computation processing while using each of the plurality of tiles as the input data,
wherein the control unit controls the computation unit so that, with respect to at least a part of the plurality of tiles, overlapping pixels which are included in the at least the part of the plurality of tiles and which correspond to the same region in the image as another tile are excluded from a target of the convolutional computation processing.

2. The image processing apparatus according to claim 1, wherein
the control unit excludes the overlapping pixels from the target of the convolutional computation processing executed by the computation unit by using, as the input data, an image configured by excluding the overlapping pixels from the at least the part of the plurality of tiles.

3. The image processing apparatus according to claim 1, wherein
the plurality of tiles are a predetermined number of partial regions set in the image, and are each an image corresponding to one of the predetermined number of partial regions that have been set to overlap at least another partial region, and
the overlapping pixels correspond to a region in which, among the predetermined number of partial regions, partial regions that have been set to neighbor each other overlap.

4. The image processing apparatus according to claim 1, wherein
the control unit controls the computation unit so as to
cause the computation unit to execute the convolutional computation processing while selecting each of the plurality of tiles as the input data in order, and
exclude the overlapping pixels included in the at least the part of the plurality of tiles from the target of the convolutional computation processing on a condition that the convolutional computation processing has been completed for the another tile.

5. The image processing apparatus according to claim 4, wherein
the control unit selects, as the input data to be used next, a tile corresponding to a partial region that neighbors a partial region corresponding to a tile that has been selected as the input data most recently in a vertical direction in the image.

6. The image processing apparatus according to claim 1, wherein
the computer program further causes the at least one processor and/or circuit to function as an output unit configured to generate output data of each of the plurality of tiles based on a result of the convolutional computation processing executed by the computation unit, and
with respect to the at least the part of the plurality of tiles, the output unit generates the output data based on a result of the convolutional computation processing executed for the at least the part of the plurality of tiles, and on a result of the convolutional computation processing executed for the another tile with respect to the overlapping pixels.

7. The image processing apparatus according to claim 6, wherein
the neural network is a convolutional neural network that includes a plurality of levels as convolutional layers, and repeatedly executes the convolutional computation processing in the plurality of levels with respect to the image,
the control unit causes the computation unit to execute the convolutional computation processing with respect to each of the plurality of tiles in each of the levels of the convolutional neural network,
with respect to an input layer of the convolutional neural network, the obtainment unit obtains images included in the plurality of partial regions set in the image as the plurality of tiles, and
with respect to a succeeding layer of the convolutional neural network, the obtainment unit obtains a plurality of pieces of the output data that have been generated by the output unit with respect to a preceding level as the plurality of tiles for the succeeding layer.

8. The image processing apparatus according to claim 7, wherein
with respect to the at least the part of the plurality of tiles corresponding to the same partial region, the control unit differentiates pixels to be excluded as the overlapping pixels in accordance with a level of the convolutional neural network.

9. The image processing apparatus according to claim 8, wherein
in each level of the convolutional neural network, the computation unit executes the convolutional computation processing with respect to each of pixels included in the input data with use of pixel values of pixels included in a predetermined region that has been determined based on the pixels included in the input data,
a size of a reception field in the image that contributes to a result of the convolutional computation processing for one pixel is determined in accordance with a level of the convolutional neural network in which the convolutional computation processing has been executed, and
the control unit determines pixels to be excluded as the overlapping pixels based on the size of the reception field in the convolutional computation processing executed by the computation unit.

10. The image processing apparatus according to claim 9, wherein
the size of the reception field becomes larger in a deeper level of the convolutional neural network, and
with respect to the at least the part of the plurality of tiles corresponding to the same partial region, the control unit causes the number of pixels to be excluded as the overlapping pixels to become smaller in a deeper level of the convolutional neural network.

11. The image processing apparatus according to claim 9, wherein
in the convolutional computation processing for the another tile, the control unit does not exclude a pixel corresponding to the reception field including a pixel that is not included in the another tile as the overlapping pixels.

12. The image processing apparatus according to claim 1, wherein
the computer program further causes the at least one processor and/or circuit to function as a generation unit configured to generate the plurality of tiles based on the image, and
the generation unit generates the plurality of tiles by setting partial regions so as not to segmentalize the image in a horizontal direction.

13. An image capturing apparatus, comprising:
an image capturing unit; and
the image processing apparatus according to claim 1,
wherein the obtainment unit obtains the plurality of tiles based on the image that has been obtained through image capture performed by the image capturing unit.

14. A control method for an image processing apparatus, the control method comprising:
executing convolutional computation processing in a neural network with respect to input data;
obtaining a plurality of tiles that respectively correspond to partial regions in an image; and
performing control so as to cause the convolutional computation processing to be executed while using each of the plurality of tiles as the input data,
wherein the control is performed so that, with respect to at least a part of the plurality of tiles, overlapping pixels which are included in the at least the part of the plurality of tiles and which correspond to the same region in the image as another tile are excluded from a target of the convolutional computation processing.

15. A computer-readable recording medium storing a program for causing a computer to execute the control method according to claim 14.
